(19) United States
(12) Patent Application Publication
(10) Pub. No.: US 2006/0100980 A1
(43) Pub. Date: May 11, 2006

(54) Methods and systems for delivering yellow pages content to a media delivery device

(75) Inventors: James Keith Reed, Marietta, GA (US); John Pumpelly, Atlanta, GA (US)

Correspondence Address: BAMBI FAIVRE WALTERS, PO BOX 5743, WILLIAMSBURG, VA, 23188, US

(73) Assignee: BellSouth Intellectual Property Corporation

(21) Appl. No.: 10/974,497

(22) Filed: Oct. 27, 2004

(51) Int. Cl. G06F 7/00; G06F 17/30

(52) U.S. Cl. 707/1

(57) ABSTRACT

A directory channel broadcasts or otherwise communicates an electronic communications directory to a media delivery device for presentment, storage, and/or integration with other directory content. The media delivery device may include an integrated multimedia device, such as an audiovisual (AV) device. Alternatively, the media delivery device and the AV device may be stand-alone devices such as an STB coupled or otherwise connected with a TV.

### CROSS REFERENCE TO RELATED APPLICATION

This application relates to applicants' co-pending application entitled “Methods And Systems For An Interactive Communications Directory And Directory Channel,” (Attorney Docket BS040195) filed simultaneously herewith, and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

The exemplary embodiments generally relate to media delivery and storage systems and, more particularly, to systems and methods for interactive delivery and storage of directory content.

Consumers typically maintain or have access to a variety of communications directories that include names, telephone numbers, geographical addresses, electronic communications addresses (e.g., email, web page, and so on), and more. For example, the consumer may have a telephone directory provided by a local service provider (e.g., BellSouth's Yellow Pages for a geographic area), a personal telephone directory (e.g., telephone numbers, email addresses, home addresses, birthdays, and other information for relatives and friends), a neighborhood directory (e.g., a listing of names, telephone numbers, addresses, and other information (e.g., position in homeowners' organization, babysitting services, pet sitting services, and so on) of property owners in a development), and other clubs and/or organizational directories (e.g., a directory of names, addresses, telephone numbers, electronic communications addresses, and other information of church members, school and/or class members, and other clubs and organizations). Some of the directory information may be stored in hard copy form, such as a handwritten directory, a directory provided to a consumer by a service provider (e.g., the Yellow Pages), a directory provided to a member from a club and/or organization, and some may be stored in electronic format (e.g., an electronic address book, a web page with directory information, and so on).

Locating a communications directory presents challenges when more than one user has access to the directory, when a user misplaces or loses the directory, and/or when a user does not actually possess the directory, but wishes to have access to the directory. And even after the user locates the directory, the user may have difficulty searching for a directory listing, such as the user trying to appropriately identify a category of providers for goods and/or services, to search for a listing in a particular geographic area, to figure out an appropriate spelling of an individual and/or business name, to easily handle a directory due to its size and/or condition (e.g., falling apart), and/or to read the directory (e.g., size of typewritten font or handwriting may be difficult to read). And, if a listing is non-published, then the directory does not contain the listing, even to identify a name of the individual or business. Further, printed directories, such as a Yellow Pages directory, may be costly to produce and/or to distribute for the provider, and consequently, the printed directory may have a limited publication and/or distribution (e.g., published once per year or other lengthy time period, distribution to a certain locations and/or hubs, and/or other limitations). Consequently, the provider directory often does not include up to date of directory listings of new listings or modifications to other listings. Still further, an advertiser may find it prohibitively expensive and/or untimely to advertise in a provider directory because the provider directory may only be occasionally produced.

Many consumers own a television (“TV”). And, in the TV industry (e.g., satellite broadcast, digital cable, telephony and more), service providers and manufacturers have started to introduce home communications terminals known as set top boxes (STBs) that may be Web-enabled and that may include computer hard drives for recording, storing, and/or playing broadcast and other media content. In addition to supporting traditional analog broadcast, many digital STBs are enhanced so that the STB can present one program while recording another program and/or so that the consumer can engage in two-way communications, such as, for example, video/audio on demand (VOD), interactive TV, Web surfing, e-mail, electronic shopping, and recording/storing/playback of broadcast programs. Many of these available services are media intensive and demand high bandwidth. And, even when media content is stored to the hard drive of an enhanced STB, the consumer has little control of organizing, modifying, and/or integrating content of the media with other stored media content (e.g., cutting and pasting from one media content into another media content to create and store an integrated file).

In view of the foregoing, it can be appreciated that a need exists for systems and methods that advantageously provide directory content. More particularly, a need exists for systems and methods that leverage assets of the consumer to provide comprehensive directory services.

### SUMMARY

The aforementioned problems, and other problems, are reduced by methods, systems, computer programs, and/or computer program products that provide comprehensive directory services to a media delivery device. Some of the embodiments, in particular, provide a directory channel that is broadcast to or otherwise communicated with a Directory Service Module of a media delivery device for storage and/or integration with other directory content and for presentment to an audio/video (AV) device. The media delivery device and the AV device may be integrated into a single device, or, alternatively, the two devices may be stand-alone devices such as a set-top box (STB) coupled or otherwise connected with a television, a computer, or a digital television. According to exemplary embodiments, a user may tune in the directory channel to view, download, search, and/or otherwise access an electronic communications directory. The electronic communications directory may include one or more directory listings of names, communications addresses, physical addresses, categories of goods and/or services, and/or other information. And because this invention stores a selected electronic communications directory to the local memory device, the user may access the directory even when the broadcast signal (or, alternate media delivery signal) is impaired. According to further exemplary embodiments, the electronic communications directory may include an associated file such as an advertisement and/or other marketing information. And, still further exemplary embodiments provide for a directory management module of the memory device includes instructions and/or commands that enable the user to access, enter, and modify a directory listing of the electronic communications directory and to create integrated directories.

In an exemplary embodiment, a media delivery device includes an electronic communications directory and a directory services module for accessing and managing directory content of the electronic communications directory. The directory signals may include the electronics communications directory and/or a media file such as a movie, sporting event, television program, audio/visual file, an advertisement, and others. The electronic communications directory includes a directory listing that includes a directory name with a communications address and may also include additional information with the directory name, such as, for example, a physical address, an identification category (e.g., a Yellow Pages category for a business listing, a personal category created by the consumer such as “January Birthdays” for a listing of an individual with a January birthday, a type of communications address such as a “mobile telephone number,” and so on), and a graphic (such as a logo, a map, and/or directions). The directory services module may store a search parameter for the directory listing and/or a user-created directory listing to create a profile of the directory listing for a future search and/or to manage the directory listing. According to further exemplary embodiments, the media delivery device includes a wireless transceiver for transmitting and receiving communications signals to a wireless device, such as a remote control device, another wireless communications device (i.e., a transceiver communicating with the media delivery device), and an input terminal that may be hard wired into the media delivery device (e.g., an integrated control panel of the media delivery device, an control panel integrated into a piece of furniture and wired to the media delivery device).

According to another exemplary embodiment, a method of providing an electronic communications directory includes receiving an electronic communications directory, storing the electronic communications directory to a media delivery device, and presenting the electronic communications directory to a multimedia device, such as an audio/visual system of the media delivery device. Further embodiments include receiving a search parameter for searching the electronic communications directory to select a directory listing, selecting the directory listing having a matched search parameter, and/or presenting the selected directory listing to the audio/visual device of the media delivery device. The search parameter may be input by actuating a pushbutton key on a wireless device (e.g., a remote control) operable to transmit and receive an encoded signal with the medial delivery device and/or with an input terminal connected with the media delivery device. The search parameter may include information for a directory name, an identification category, a geographic area, and/or other associated information (e.g., profile information of a directory listing). Still further embodiments include simultaneously presenting the electronic communications directory (or the selected directory listing) with a media file to the audio/visual device. And, still further embodiments include receiving a request to search a remote database for information associated with the selected directory listing, retrieving the remotely stored information, presenting the remotely stored information, and locally storing the remotely stored information.

According to yet another exemplary embodiment, a computer program product includes instructions for receiving an electronic communications directory, storing the electronic communications directory to a media delivery device, presenting the electronic communications directory to an audio/visual system of the media delivery device, receiving a search parameter, selecting the directory listing(s) that match the search parameter, and presenting the selected directory listing to the media delivery device. Further embodiments include instructions for receiving a request to search a remote database for information associated with the selected directory listing, retrieving the remotely stored information, presenting the remotely stored information, and locally storing the remotely stored information.

Other systems, methods, and/or computer program products according to embodiments will be or become apparent to one with skill in the art upon review of the following drawings and detailed description. It is intended that all such additional systems, methods, and/or computer program products be included within and protected by this description and be within the scope of the patent.

### DESCRIPTION OF THE DRAWINGS

The above and other embodiments, objects, uses, advantages, and novel features are more clearly understood by reference to the following description taken in connection with the accompanying figures, wherein:

FIG. 1 illustrates a block diagram of exemplary details of a media delivery device according to some of the exemplary embodiment;

FIG. 2 is a simplified schematic of an operating environment according to some of the exemplary embodiment;

FIG. 3 depicts a schematic of an exemplary operating environment according to some of the exemplary embodiment;

FIG. 4 illustrates a schematic of another exemplary operating environment according to some of the exemplary embodiment;

FIG. 5 is a schematic of still another exemplary operating environment according to some of the exemplary embodiment;

FIG. 6 depicts an alternate block diagram of exemplary details of another media delivery device according to some of the exemplary embodiment; and

FIGS. 7 and 8 are flowcharts illustrating a method of providing directory services to a media delivery device according to some of the exemplary embodiment.

### DESCRIPTION

The exemplary embodiments now will be described more fully hereinafter with reference to the accompanying drawings, in which exemplary embodiments are shown. These exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods and computer program products embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The exemplary embodiments include methods, systems, computer programs, and/or computer program products that provide comprehensive directory services to a media delivery device. According to some of the embodiments, a directory channel broadcasts or otherwise communicates an electronic communications directory (also referred to herein as “directory”) with a media delivery device for storage and/or integration with other directory content and for presentment to an AV device of the media delivery device. For example, a service provider such as a telecommunications provider (e.g., BellSouth) and/or a data service provider (e.g., America Online (AOL)) may broadcast or otherwise communicate the directory of communications listings and/or other media content via the directory channel. Similarly local clubs, organizations, and/or facilities (e.g., a church, a homeowners' association, a school, a soccer club, and/or others) may provide a customized electronic communications directory of listings tailored for members and/or non-members to the directory channel. Regardless of the provider for the directory, the directory is communicated to the media delivery device for presentment to the user (also referred to herein as the “consumer,” “viewer,” and/or “customer”). The media delivery device may include an integrated multimedia device, such as an audiovisual (AV) device, or alternatively, the media delivery device and the AV device may be stand-alone devices such as an STB coupled or otherwise connected with a TV.

According to some of the exemplary embodiment, the user may tune in the directory channel to view the broadcast of one or more electronic communications directories. The user may use an input terminal, a remote control device, and/or an alternate device to select a directory to download and store to memory of the media delivery device, such as to the hard drive of an STB. Thereafter, a request is communicated to a data source associated with the selected directory, and, in response, the directory is communicated and stored to the memory of the media delivery device. The electronic communications directory may include one or more listings of names, communications addresses, physical addresses, categories of goods and/or services, and/or other associated information. For example, the directory may include promotional media such as an advertisement and/or other marketing information. The promotional media may be presented by itself or presented simultaneously with one or more listings of the electronic directory such as a split and/or dual display screen with one or more listings in one portion of the screen and the promotional material in the other portion. Other exemplary embodiments provide that the directory listings are stored to the media delivery device while promotional material is broadcast and synchronized for presentment with the listings. Still further, a directory services module of the memory device includes instructions and/or commands that enable the user to access, enter, and/or modify a directory listing of the directory and/or to create an integrated directory. For example, the user may cut and paste a listing from a White Pages directory and/or a Yellow Pages directory provided by a local service provider into a personalized directory of the user. Another example is when the user obtains a non-published listing or an updated listing, and, for these listings, the user may enter the non-published or updated information into any directory stored to the memory device. And because this invention stores the directory to a local memory device, the user may access the directory even when the broadcast signal (or, alternate media delivery signals) is impaired. Further exemplary embodiments provide that a locally stored directory of the media delivery device may be updated (automatically or manually, such as a user requesting or responding to a prompt to load an updated directory) with supplemental information without having to download and store an entirely new updated directory. And, if the user has customized a directory listing that is also contained in the updated directory, the directory services module confirms modification to the subscriber's directory listing to reconcile any discrepancies of the updated information and the subscriber's personal annotations, modifications, and/or additional information of the directory listing.

As used herein, the term “directory” includes a listing a name of an individual and/or a business, a listing of a category and/or services, a physical address, a telecommunications address (e.g., a telephone number), an electronic communications address (e.g., an email address), and/or other associated information (e.g., personalized information of an individual such as a birthday, helpful information for a business such as hours of operation, acceptable means of payment, a map within a proximate area of the listed business address, and incentives and/or other promotional material, and/or helpful information for a club and/or organization such as a calling tree for passing messages, identification of officers with responsibilities, and other helpful information). A customer of this directory service may access any electronic directory that is locally stored at the customer's premise. This directory service, however, also provides for interactive communications with a remote directory server. Using this service the customer may download a selected directory, a media file, and/or associated information via a broadband terrestrial communications link, such as a digital subscriber line (DSL), a coaxial cable, and/or a fiber optic line. Alternate communications links, such as a wireless communications link may be used to communicate the selected directory, media file, and/or associated information to the media delivery device. Further, as used to describe some of the embodiments, the term “electronic communications directory” encompasses video, audio, audio-video, text, graphics, facsimile, data, animation, and combinations thereof.

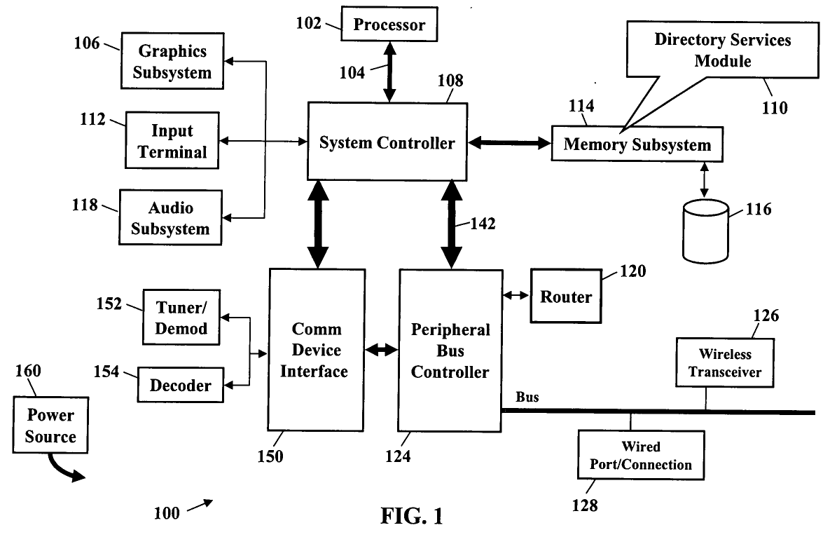

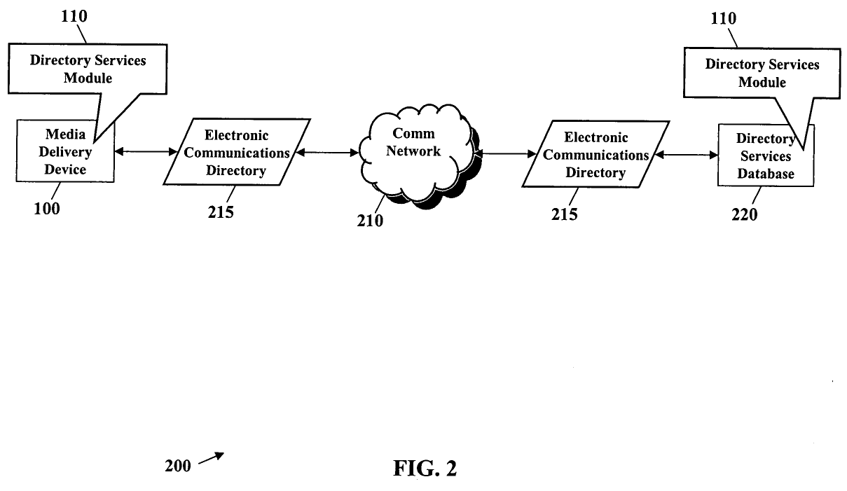

Referring now to the figures, FIG. 1 is a block diagram showing a Directory Service Module 110 residing in a computer system shown as a media delivery device 100. As FIG. 1 shows, the Directory Service Module 110 operates within a system memory device. The Directory Service Module 110, for example, is shown residing in a memory subsystem 114. The Directory Service Module 110, however, could also reside in flash memory or a peripheral storage device 116. The media delivery device 100 also has one or more central processors 102 executing an operating system. The operating system, as is well known in the art, has a set of instructions that control the internal functions of the media delivery device 100, and furthermore has the capability to communicate a communications signal between the media delivery device 100 and a communications network (shown as reference numeral 210 in FIG. 2) and/or an alternate communications device (e.g., a TV connected with the media delivery device 100, a wireless transceiver in an electronic device such as a remote control device, an appliance, and/or a communications device, and others).

The system controller 108 provides a bridging function between the one or more central processors 102, a video/graphics subsystem 106, an input terminal 112, and an audio subsystem 118, the memory subsystem 114, a PCI (Peripheral Controller Interface) bus, and a Communications (“Comm”) Device Interface 150. The PCI bus is controlled by a Peripheral Bus Controller 124. The Peripheral Bus Controller 124 (typically called a “Southbridge”) is an integrated circuit that serves as an input/output hub for various peripheral ports and/or transceivers. The Peripheral Bus Controller 124 allows for communications with connected devices and/or a communications network. The peripheral ports allow the media delivery device 100 to communicate with a variety of devices (alternate input terminals) through networking ports (such as SCSI or Ethernet, not shown) and/or transceivers that include Wireless Communications (“Comm”) Device Transceiver 126 (for communication of any frequency signal in the electromagnetic spectrum, such as, for example, the 802 family of standards and Infrared) and Wired Communications (“Comm”) Device Port/Connection 124 (such as modem V90+ and compact flash slots). These peripheral ports could also include other networking ports, such as, a serial port (not shown) and/or a parallel port (not shown). The Peripheral Bus Controller 124 may further control communications with the input terminal 112. Further, a tuner/demodulator 152 may receive encoded digital signals (e.g., signals from a satellite receiver, a cable feed, and so on). The digital signals are divided into audio and video signals. The tuner/demodulator 152 tunes to the frequency of a broadcast media stream that is selected by the user. The tuner/demodulator 152 feeds the digital signals into a decoder 154 (either directly or via the Communications Device Interface 150). The tuner/demodulator tunes to the frequency of a selected decoder transport stream that is then decoded and fed to the graphics and audio subsystems 106, 118, such as A/V out jacks to a TV. Further, the media delivery device 100 may include a power source 160, such as, for example, a rechargeable battery to provide power and allow the media deliver device 100 to be portable. Still further, the peripheral bus controller 240 may provides a biometric interface with a subscriber. The biometrics interface provides an alternate medium for the media delivery device 100 and the subscriber to access, communicate, control, and/or store data to the electronic communications directory and provides additional security features that prevent unauthorized users from exploiting the electronic directories of the media delivery device. The biometrics interface may include a sensor to verify the subscriber such as a retina recognition device and software, DNA/RNA recognition device and software, facial recognition device and software, speech recognition device and software, and/or scent recognition device and software. Additionally, those of ordinary skill in the art understand that the program, processes, methods, and systems described in this patent are not limited to any particular computer system or computer hardware.

Those of ordinary skill in the art also understand the central processor 102 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular central processor of a manufacturer.

The operating system may be a UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems may include a WINDOWS-based operating system (WINDOWS® is a registered trademark of Microsoft Corporation, One Microsoft Way, Redmond Wash. 98052-6399, 425.882.8080, www.Microsoft.com) and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

According to an embodiment, the memory subsystem 114 operates with the processor 102 to maintain a list of television stations (or other multimedia delivery mediums) that are available to the viewer in accordance with a subscription plan. In order to select a channel, the processor 102 either receives signals from the input terminal 112, the wireless transceiver 126, and/or a device coupled or otherwise connected with the wired port/connection 128. Further, the system memory device (shown as memory subsystem 114 and/or peripheral storage device 116) may also contain an application program that cooperates with the operating system and with other input/output devices (e.g., the graphics subsystem 106, the input terminal 112, the audio subsystem 118, and/or an alternate multimedia device providing an AV interface to the user) to provide a graphical user interface (GUI). The graphical user interface provides a convenient visual and/or audible interface with the media delivery device 100. For example, a directory services module 110 provides a GUI that enables the user to access, modify, create, distribute, and/or otherwise manage an electronics communications directory (shown as reference numeral 215 in FIG. 2). And, according to an exemplary embodiment, the directory services module 110 is presented by a subscriber actuating a yellow pushbutton coded with the words “Yellow Pages” of an infrared remote control device. That is, the subscriber presses the “Yellow Pages” pushbutton, and the remote transmits the encoded signal to the media delivery device to present the directory services module 110.

As shown in FIG. 2, a directory services operating environment 200 includes the media delivery device 100 having the Directory Service Module 110, a communications network 210, and a directory services database 220. The media delivery device 100 can be any device, such as an analog/digital recorder, television, CD/DVD player/recorder, audio equipment, receiver, tuner, and/or any other consumer media delivery device 100. The media delivery device 100 may also include any computer, peripheral device, camera, modem, storage device, telephone, personal digital assistant, and/or mobile phone. The communications network 210 may be a television/cable network operating in the radio-frequency domain and/or the Internet Protocol (IP) domain. The communications network 210, however, may also include a distributed computing network, such as the Internet (sometimes alternatively known as the “World Wide Web”), an intranet, a satellite network, a telecommunications network (e.g., Public Switched Telephone Network, Mobile Switching Telephone Office, and others), a local-area network (LAN), and/or a wide-area network (WAN). The communications network 210 may include coaxial cables, copper wires, fiber optic lines, and/or hybrid-coaxial lines. The communications network 210 may even include wireless portions utilizing any portion of the electromagnetic spectrum and any signaling standard (such as the I.E.E.E. 802 family of standards).

As shown in an embodiment of FIG. 2, the media delivery device 100 receives the electronic communications directory 215 from a content provider of the directory services database 220 via the communications network 215. The electronic communications directory 215 may be any RF and/or digital content, such as data files, television/cable programming, mpg streams, or any other multimedia content. When the media delivery device 100 receives the electronics communications directory 215, the electronics communications directory 215 may be stored to the memory subsystem 114 and/or to a peripheral storage device 116. According to another embodiment, the user may create or otherwise customize the electronics communications directory 215 and transmit the customized electronics communications directory 215 to the directory services database 220 via the communications network 210. The directory services database 220 may remotely store the customized electronics communications directory 215 to provide a backup service and/or to distribute the customized electronics communications directory 215 to other devices.

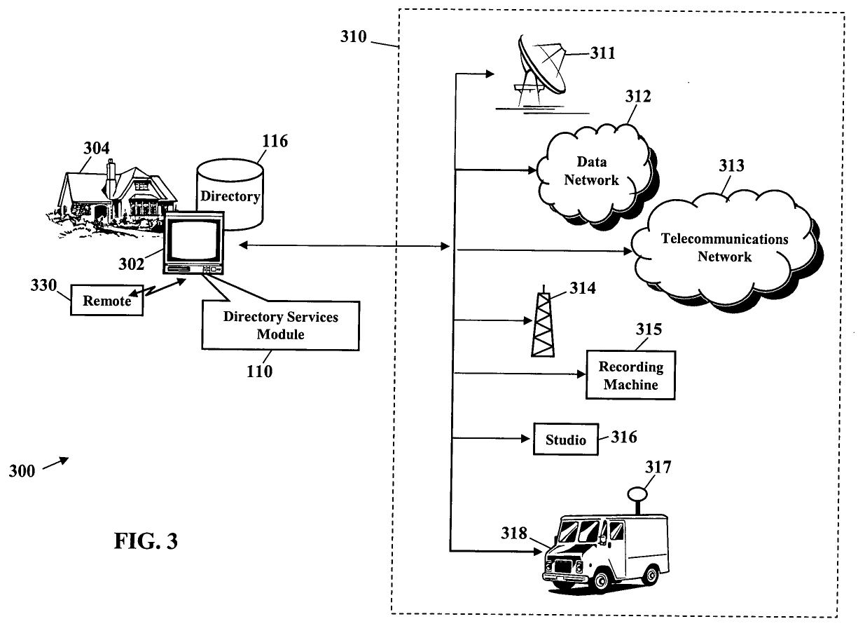

FIG. 3 depicts an exemplary embodiment of a directory services operating environment 300. The directory services operating environment 300 illustrates a residence 302 with a media delivery device shown as an integrated set top box and television 302 having the directory services module 110 and the electronic communications directory 215 stored in database 116, a remote control device 330, and a communications network 310. The media delivery device 302 receives graphics, audio and other forms of the electronic communications directory 215 from one or more communications networks that include a variety of broadcasts and communication mediums. As shown in FIG. 3, these broadcast systems may include a direct digital broadcast via satellite TV 311, a communication link with a data communications network 312, a communications link with a telecommunication network 313, a broadcast via digital cable TV 314, and/or a terrestrial broadcast analog and/or digital TV such as a broadcast from a recording device 315, a studio 316, or a mobile vehicle 318 with an antenna and receiver 317. Further, the directory service module 110 may interact with a directory-on-demand service (or an alternate source that provides the electronic communications directory) via a web browser or alternate interface to present a menu to a display device of the media delivery device 100. If the directory services module 110 uses the web browser, then an application server may respond to Hyper-Text Transfer Protocol (HTTP) requests by processing the requested URL and parameters according to the services it is providing. This may require accessing and/or storing data (e.g., the electronics communications directory) in a server database. According to an exemplary embodiment, the directory-on-demand service stores the electronics communications directory and related information as Extensible Style Sheet (XSL) documents that allow the XML directory-on-demand information to be translated into HTML using an XSL processor. The server application (within the communications network) then translates the XML data into HTML data and transmits it to the web browser that presents the HTML data of the electronics communications directory to the display device, such as a computer monitor or a television screen. The information presented, for example, may include information about electronic communications directories (including updated directories for a supplemental download), maps, appointment scheduling, advertisements, and/or other related information that is available via the directory-on-demand service. According to another exemplary embodiment, Real Simple Syndication (RSS) that uses XML structures may be similarly used to feed electronic communications directories and related information from a source (e.g., the directory-on-demand service provider in the communications network) to a destination (e.g., the media delivery device 100).

Typically, the user initiates a directory services session with the multimedia device 302 by interfacing with the directory services module 110 by actuating a pushbutton of the remote control device 330, by voice commands, and/or by other selection methods. According to some of the embodiments, the Directory Service Module 110 presents a graphical user interface that enables a broad range of functionality for accessing, modifying, creating, distributing, and/or otherwise managing the electronics communications directory 215. For example, an infrared remote control, an input terminal, and/or an optional wireless keyboard can communicate with the media delivery device 100 to interact with the graphical user interface that is presented on an audio/visual device such as a TV screen. According to one of the exemplary embodiment, furniture (e.g., a couch, a chair, a table, and other furniture) having an integrated input terminal, control panel, and/or communications interface with the media delivery device 100 is used to select the directory to access, download, store, and/or otherwise manage and to further act as an input/output with the directory services module 110. The graphical user interface may be used to access one ore more electronic communications directories, associated broadcast and on-demand video and audio content, and associated multimedia applications and services.

To view the directory channel and/or the electronic communications directory, the user can use an infrared remote control (or alternate input/output device) to select the electronic communications directory that he or she wants to access and/or to download by utilizing an electronic communications directory program guide, a search function, entering a channel number, and so on. After the user makes a selection, the directory services module 110 determines if the selected electronic communications directory 215 is locally or remotely stored. If the selected electronic communications directory 215 is remotely stored, then the directory services module 110 communicates a request via the communications network 310 to access or download the selected electronics communications directory 215 to the media delivery device 302. Thereafter, the selected electronic communications directory is displayed an audio/visual display of the media delivery device 302 and the user actuates a pushbutton of the remote control device 330 to enter a search parameter, create a new directory listing, modify an existing directory listing, request associated information (e.g., map and/or directions to an address), and so on.

According to some embodiments, the user may be required to provide an identity and/or a password to access, download, and/or otherwise manage the electronic communications directory 215. For example, the user may be prompted to enter a personal identifier that may used to distinguish between different members of a household. Accordingly, the ability to distinguish among different users enables each user to secure information, such as safeguarding a non-published telephone number or maintaining privacy of a selected directory listing in a shared electronics communications directory (e.g., presenting a directory listing having the name and communications address to only some users). In an alternate embodiment, the media delivery device 302 may be configured to automatically access and/or present the electronic communications directory for a previously initiated session each time the media delivery device is powered on.

In further embodiments, the media delivery device 302 may simultaneously present other associated broadcast media (or alternate data) during the presentment of the electronics communications directory 215. For example, if the user searches an electronic communications directory 215 for a category of services such as “Automobile Dealers,” then the media delivery device 302 may present a split screen with a portion of the screen having the listings of matched Automobile Dealers in one portion and with the other portion of the screen having associated multimedia content such as an advertisement paid for by one of the listed Automobile Dealers. Still further, during the presentment of the multimedia stream, the directory services module 110 may insert instruction signals and/or prompts into the multimedia stream, and, thus allow the user to associate, select, or otherwise respond to the instruction signal. For example, the Automobile Dealer advertisement may include an instructional signal for automatically establishing a communications connection with the Automobile Dealer.

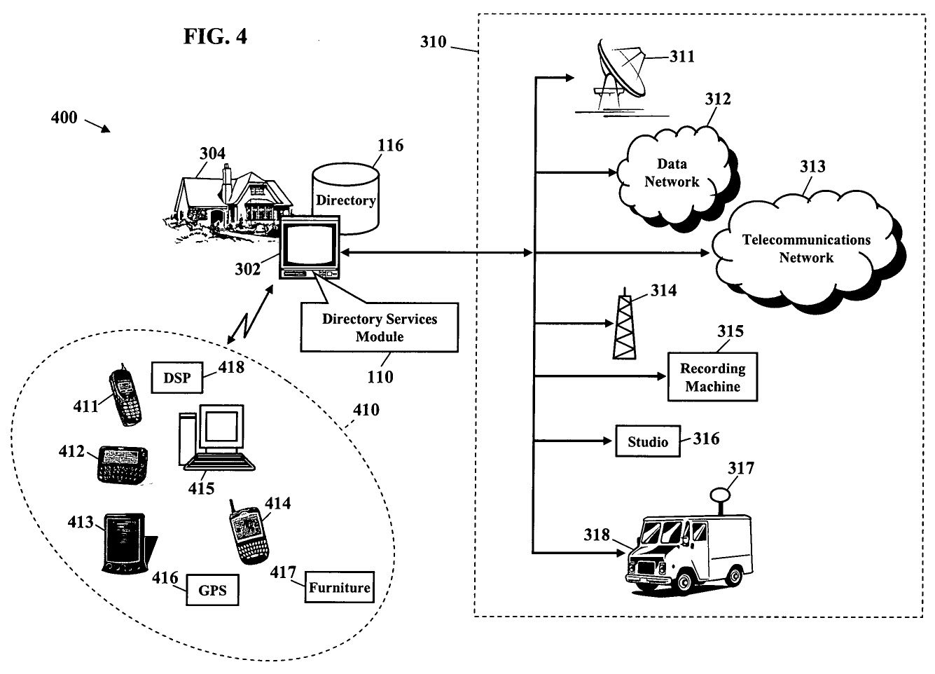

FIG. 4 illustrates another directory services operating environment 400. As shown in FIG. 4, the media delivery device 302 can further communicate the electronic communications directory 215 and/or the associated multimedia content to a wide range of communications devices having a graphical display 410, including a cellular phone 411, an interactive pager 412, a personal digital assistant (PDA), a Voice over Internet Telephony (VoIP) phone 414, a computer system 415, a global positioning system (GPS) 416, a control panel integrated into a piece of furniture such as a couch, chair, or table 417, and any device having a digital signal processor (DSP) 418. For example, the media delivery device 302 may communicate the electronic communications directory 215 to a watch, a radio, vehicle electronics, a clock, a printer, a gateway, and/or another apparatus and system. And, because the communications device 410 may have limited capabilities, the media delivery device 302 may only communicate a portion of the electronics communications directory 215 (e.g., the name of a directory listing and the communications address) and/or a portion of a graphical user interface of the directory services module 110. Similar to the remote control device 330 of FIG. 3, the communications device 410 communicates with the directory services module 110 of the media delivery device 302 to access, create, modify, and/or otherwise manage the electronic communications directory 215. Further, the communications device 410 may provide a convenient medium for the user to establish a communications link with the selected directory listing. For example, if the communications device 410 provides a signal to select a directory listing for “John Adams” and thereafter selects to initiate a communications link with the communications address for John Adams, then the media delivery device 302 may initiate the communications link with the communications address for John Adams and connect the communications device 410 when the link is established.

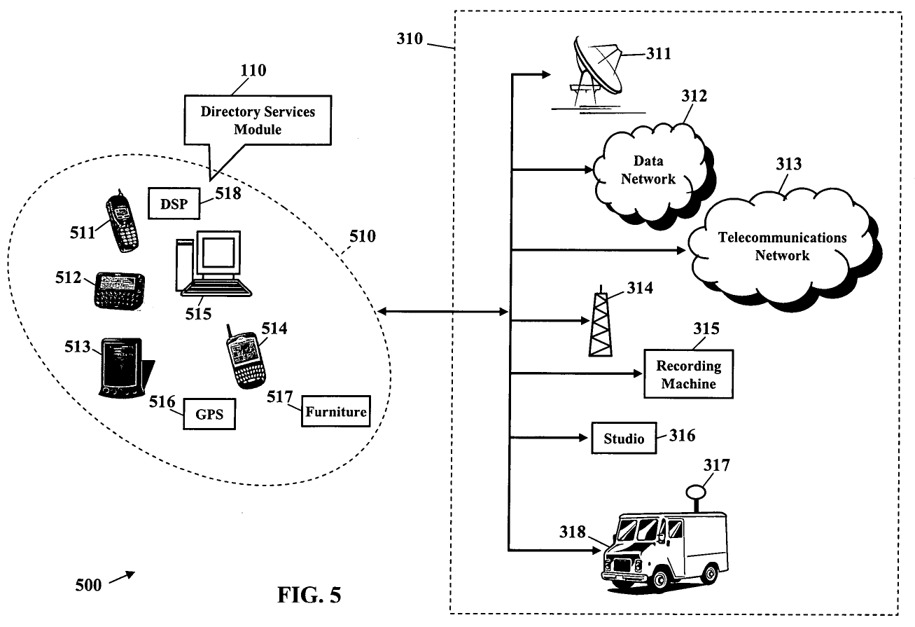

Referring now to FIG. 5, another directory services operating environment 500 depicts alternate media delivery devices 510 communicating the electronic communications directory and/or associated multimedia content with the communications network 310. These alternate media delivery devices 510 include including a cellular phone 511, an interactive pager 512, a personal digital assistant (PDA), a Voice over Internet Telephony (VoIP) phone 514, a computer system 515, a global positioning system (GPS) 516, a control panel integrated into a piece of furniture such as a couch, chair, or table 517, and any device having a digital signal processor (DSP) 518. Alternate media delivery devices may further include a watch, a radio, vehicle electronics, a clock, a printer, a gateway, and/or another apparatus and system having an AV output. Because these alternate media delivery devices 510 may have limited capabilities, the Directory Service Module 110 may access a remote database (either the directory services database 220 of FIG. 2 and/or another remote database provided by a third party provider such as an online mapping service) to access, modify, and/or otherwise manage the electronic communications directory and/or associated information including associated multimedia files.

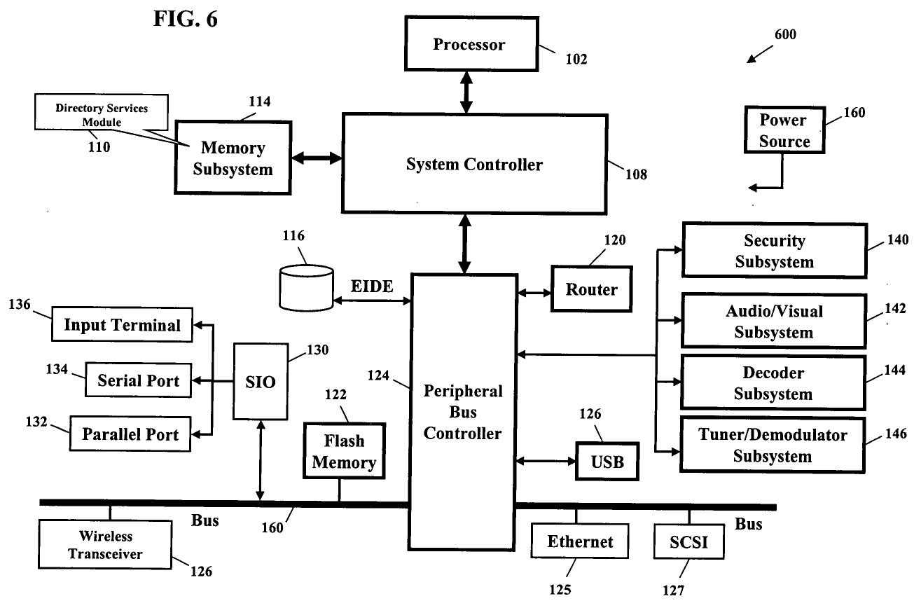

FIG. 6 depicts another block diagram of the directory services module 110 residing in an alternate computer system shown as media delivery device 600. As FIG. 6 shows, the directory services module 110 operates within a system memory device. The directory services module 110, for example, is shown residing in a memory subsystem 114. The directory services module 110, however, could also reside in flash memory 122 or the peripheral storage device 116. The media delivery device 600 also has one or more central processors 102 executing an operating system. The operating system has a set of instructions that control the internal functions of the media delivery device 600. The system controller 108 provides a bridging function between the one or more central processors 102, a security subsystem 140, an audio/visual subsystem 142, a decoder subsystem 144, a tuner/demodulator subsystem 146, the memory subsystem 114, the peripheral storage device 116, a router 120, flash memory 122, and with other components such as input/output devices communicating with a PCI (Peripheral Controller Interface) bus 160. The PCI bus 160 is controlled by a Peripheral Bus Controller 124. The Peripheral Bus Controller 124 (a “Southbridge”) is an integrated circuit that serves as an input/output hub for various peripheral ports and/or transceivers. The above-identified peripheral ports allow the media delivery device 600 to communicate with a variety of devices through networking ports (such as SCSI 127 or Ethernet 126) and/or transceivers that include Wireless Communications (“Comm”) Device Transceiver 126 (for communication of any frequency signal in the electromagnetic spectrum, such as, for example, the 802 family of standards and Infrared) and wired communications ports/connections (such as modem V90+ and compact flash slots). These peripheral ports also include other networking ports, such as, a parallel port 132 and/or a serial port 134. Still further, the media delivery device 600 includes a power source 160, such as a rechargeable battery to provide power and allow the media delivery device 600 to be portable. Again, those of ordinary skill in the art understand that the program, processes, methods, and systems described in this patent are not limited to any particular computer system or computer hardware.

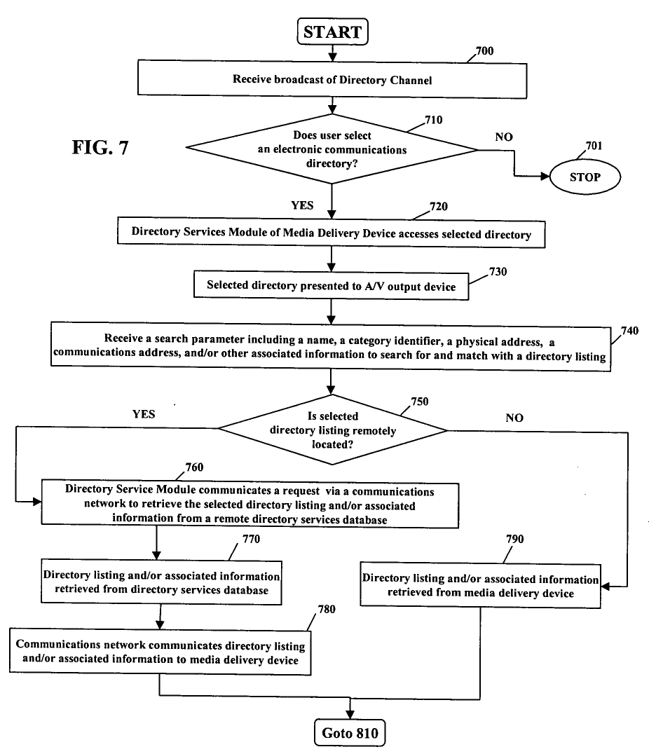

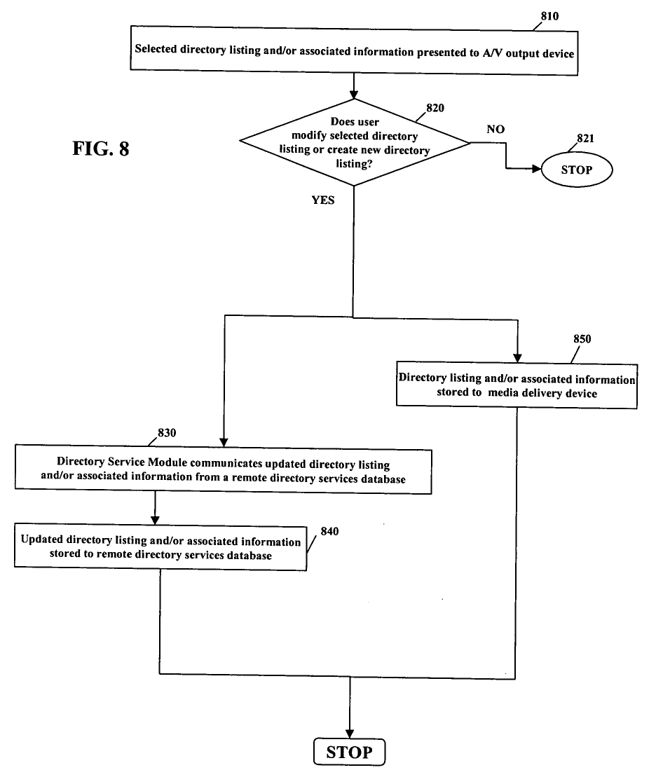

FIGS. 7-8 are flowcharts showing exemplary processes of providing directory services. A directory service provider broadcasts or otherwise communicates a directory channel to a media delivery device via a communications network [block 700]. Thereafter, a multimedia device, such as an audiovisual (AV) device, of the media delivery device presents a directory service interface that enables a user to select an electronic communications directory to access, create, modify, forward, and/or otherwise manage. If the user does not select the directory, then the process stops [block 701]. Otherwise, if the user selects the directory, then a computer program product referred to as a directory services module accesses the selected directory [block 710]. For example, if the user selects a Yellow Pages directory for a particular geographic area (e.g., Richmond, Va.), then the directory services module accesses the selected Yellow Pages provided by a service provider. The selected directory is presented to an audio/visual subsystem of the media delivery device so that the user sees and/or hears the directory information [block 730]. Thereafter, the user may input a search parameter, such as, for example, a name of an individual and/or a business, a listing of a category and/or services, a physical address, a telecommunications address (e.g., a telephone number), an electronic communications address (e.g., an email address), and/or other associated information (e.g., personalized information of an individual such as a birthday, helpful information for a business such as hours of operation, acceptable means of payment, a map within a proximate area of the listed business address, and incentives and/or other promotional material, and/or helpful information for a club and/or organization such as a calling tree for passing messages, identification of officers with responsibilities, and other helpful information) [block 740]. The Directory Service Module searches the directory for a matching directory listing and then determines if the matching directory listing is remotely stored and/or locally stored [block 750]. If the selected directory listing is remotely stored, then the method continues with the directory services module communicating a request to the remote directory services database to retrieve the selected directory listing, associated information, and/or the directory [block 760]. The selected directory listing, associated information, and/or the directory is retrieved [block 770] and communicated to the media delivery device via the communications network [block 780]. If, however, the selected directory listing is locally stored, then the method continues with the directory services module retrieving the selected directory listing from the media delivery device (and/or a local database coupled thereto) [block 790].

As shown in FIG. 8, the method then continues with presenting the selected directory listing and/or associated information to the multimedia device (e.g., AV device) [block 810]. The user may then view and/or hear the selected directory listing and/or the associated information. If the user wishes to modify the selected directory listing and/or create a new directory listing, then the method continues and the modified and/or new directory listing is saved to the remote database and/or the media delivery device. The directory services module may communicate the updated directory listing and/or associated information to the remote directory services database [block 830], and then the updated directory listing and/or associated information may stored to the directory services database [block 840]. Further, the directory services module may store the updated directory listing and/or associated information to the media delivery device [block 850]. If the user does not modify the selected directory listing and/or create a new directory listing, then the process ends. While the processes in FIGS. 7-8 are shown in series, these processes may occur in different orders and/or at simultaneous times as one of ordinary skill in the art will understand.

While several exemplary implementations of embodiments of this invention are described herein, various modifications and alternate embodiments will occur to those of ordinary skill in the art. Accordingly, this invention is intended to include those other variations, modifications, and alternate embodiments that adhere to the spirit and scope of this invention.

What is claimed is:

1. A media delivery device, comprising:
an electronic communications directory having a directory listing of at least one directory name with a communications address, the directory name further associated with at least one of an identification category and a physical address; and
a directory services module for accessing and managing directory content of the electronic communications directory for presentation to a multimedia device.

2. The media delivery device of claim 1, wherein the directory services module is further operable for creating the directory listing and a profile of one or more search parameters associated with a selection for the directory listing.

3. The media delivery device of claim 1, further comprising:
a wireless transceiver for transmitting and receiving communications signals to a wireless device.

4. The media delivery device of claim 3, the wireless device comprising a remote control device for remotely interfacing with the media delivery device.

5. The media delivery device of claim 2, wherein a media file is presented to the multimedia device simultaneously with the electronic communications directory.

6. The media delivery device of claim 2, wherein the wireless device comprises at least one of:
a mobile phone,
a cellular phone,
a WAP phone,
a satellite phone
a computer,
a modem,
a pager,
a personal digital assistant,
an interactive television,
a digital signal processor,
an appliance, and
a Global Positioning System device.

7. The media delivery device of claim 1, further comprising:
an input terminal for inputting information to the directory service module.

8. The media delivery device of claim 1, further comprising:
a network connection for transmitting and receiving the directory signals between the media delivery device and an external network.

9. The media delivery device of claim 1, wherein the directory listing comprises one of a yellow pages directory listing, a white pages directory listing, and an electronic mail directory.

10. A method, comprising the steps of:
receiving an electronic communications directory, the electronic communications directory having a directory listing of at least one directory name with a communications address, the directory name further associated with at least one of an identification category and a physical address;
storing the electronic communications directory to a media delivery device; and
presenting the electronic communications directory to a multimedia device.

11. The method of claim 10, further comprising the steps of:
receiving a search parameter for searching the electronic communications directory to select a directory listing, the search parameter comprising at least one of the directory name, the identification category, and a geographic area associated with the physical address;
selecting the directory listing having a matched search parameter; and
presenting the selected directory listing to the multimedia device.

12. The method of claim 10, further comprising the step of:
simultaneously presenting a media file to the multimedia device.

13. The method of claim 10, further comprising the steps of:
receiving a request to search a remote database for information associated with the selected directory listing;
retrieving the remotely stored information;
presenting the remotely stored information to the multimedia device; and
storing the remotely stored information to the media delivery device, the remotely stored information having a link to the associated directory listing.

14. The method of claim 10, wherein the directory listing comprises at least one of a yellow pages directory listing, a white pages directory listing, an electronic mail directory, and a directory listing created by a subscriber.

15. The method of claim 10, further comprising the step of:
simultaneously presenting a broadcast stream with the electronic communications directory to the multimedia device.

16. The method of claim 10, further comprising the steps of:
receiving a request to create a new directory listing;
retrieving a directory listing profile to present to the media delivery device;
receiving data to populate the directory listing profile, the data transmitted from an input device communicating with the media delivery device; and
storing the new directory listing to a selected electronic communications directory.

17. The method of claim 15, further comprising the steps of:
receiving a request to modify data of the directory listing;
retrieving and presenting a profile of the data of the directory listing to the media delivery device;
receiving modified data to update the directory listing, the modified data transmitted from an input device communicating with the media delivery device; and
storing the modified directory listing to a selected electronic communications directory.

18. The method of claim 10, further comprising the step of:
limiting access to one or more directory listings of the electronic communications directory.

19. A storage medium on which is encoded instructions for performing the following steps of:
receiving an electronic communications directory, the electronic communications directory having a directory listing of at least one directory name with a communications address, the directory name further associated with at least one of an identification category and a physical address;
storing the electronic communications directory to a media delivery device; and
presenting the electronic communications directory to a multimedia device.

20. The storage medium of claim 19, further comprising instructions for performing the steps of:
receiving a search parameter for searching the electronic communications directory to select a directory listing, the search parameter comprising at least one of the directory name, the identification category, and a geographic area associated with the physical address; and
selecting the directory listing having a matched search parameter; and
presenting the selected directory listing to the multimedia device.

21. The storage medium of claim 19, further comprising instructions for performing the steps of:
receiving a request to search a remote database for information associated with the selected directory listing;
retrieving the remotely stored information;
presenting the remotely stored information to the multimedia device; and
storing the remotely stored information to the media delivery device, the remotely stored information having a link to the associated directory listing.

22. The storage medium of claim 19, further comprising instructions for performing the steps of:
receiving a request to create a new directory listing;
retrieving a directory listing profile to present to the media delivery device;
receiving data to populate the directory listing profile, the data transmitted from an input device communicating with the media delivery device; and
storing the new directory listing to a selected electronic communications directory.

23. The storage medium of claim 19, further comprising instructions for performing the steps of:
receiving a request to modify data of the directory listing;
retrieving and presenting a profile of the data of the directory listing to the media delivery device;
receiving modified data to update the directory listing, the modified data transmitted from an input device communicating with the media delivery device; and
storing the modified directory listing to a selected electronic communications directory.
